(19) United States
(12) Patent Application Publication
(10) Pub. No.: US 2016/0337788 A1
(43) Pub. Date: Nov. 17, 2016

(54) SMART BAG HAVING FUNCTION OF NOTIFYING RECEPTION OF MOBILE COMMUNICATION TERMINAL, AND METHOD OF NOTIFYING RECEPTION UTILIZING THE SAME

(71) Applicant: Kolon Industries, Inc., Gwacheon (KR)

(72) Inventors: Sei-Yoon PARK, Yongin (KR); Byeong-Kwan LEE, Yongin (KR); Young-Jun KANG, Yongin (KR); Yun-Jeung JEE, Yongin (KR); Jung-Hoon PARK, Yongin (KR); Won-Jong KO, Yongin (KR)

(21) Appl. No.: 15/136,257

(22) Filed: Apr. 22, 2016

(30) Foreign Application Priority Data
May 11, 2015 (KR) 10-2015-0065621

(51) Int. Cl. H04W 4/00; H04W 76/02

(52) U.S. Cl. CPC H04W 4/008; H04W 76/023

(57) ABSTRACT

Disclosed is a smart bag having a function of notifying a reception of a mobile communication terminal, the smart bag including: a notifying device including a label attached onto one surface of an external side of the smart bag and a backlight combined with one surface of the label; a Bluetooth chip, which is electrically connected with the notifying device and pairs the mobile communication terminal and the notifying device; and a near field communication (NFC) chip, which is attached to one surface of an inner side of the smart bag and activates a Bluetooth function of the mobile communication terminal, in which the Bluetooth chip receives a signal from the mobile communication terminal, so that the backlight is turned on, so that it is possible to confirm a received signal of the mobile communication terminal even outside of the smart bag.

### CROSS-REFERENCE TO RELATED APPLICATIONS

This application claims priority to and the benefit of Korean Patent Application No. 10-2015-0065621 filed in the Korean Intellectual Property Office on May 11, 2015, the entire contents of which are incorporated herein by reference.

### TECHNICAL FIELD

The present invention relates to a technology for pairing a smart bag and a mobile communication terminal, which enables a user to visually recognize a signal reception of a mobile communication terminal located inside a smart bag from the external side of the smart bag.

### BACKGROUND ART

According to the propagation of a mobile communication terminal, most of the users always possess the mobile communication terminals, and put the mobile communication terminals in pockets of clothes, bags, or the like and always carry the mobile communication terminals. Further, the mobile communication terminal has been rapidly developed to a smart phone, a note pad, and the like having various smart functions.

Together with the development of the mobile communication terminal, the mobile communication terminal comes to have more configurations and a larger screen, and thus, a volume of the mobile communication terminal has inevitably increased.

Accordingly, it is gradually difficult to put the mobile communication terminal in a pocket, and many users carry the mobile communication terminal by utilizing a separate accommodating space, such as a bag.

When the mobile communication terminal is accommodated in a separate accommodating space, it is very difficult for users to recognize a bell sound, vibrations, lamp light emission, and the like generated when the mobile communication terminal receives a signal, and thus there are frequently incurred cases where many users miss important calls, or respond to a short text message (SMS), a smart messenger, and the like late.

In order to solve the problem, a device, which displays a reception signal of a mobile communication terminal to the external side of a bag by connecting the bag and the mobile communication terminal through a cable, has been conceived, but the device is inconvenient in that whenever a user puts in and takes out the mobile communication terminal from the bag, the user needs to directly and manually connect the mobile communication terminal and the bag, and further, the unnecessary cable is mounted to the bag utilized as a fashion item, thereby degrading an aesthetic appearance of the bag.

### SUMMARY OF THE INVENTION

The present invention has been made in an effort to notify a received signal of the mobile communication terminal to the outside of a smart bag even without a manual operation of a user by automatically pairing the mobile communication terminal and the smart bag when the mobile communication terminal is positioned within a predetermined range inside the smart bag at least one time.

The present invention has also been made in an effort to notify a received signal of the mobile communication terminal to the outside of a smart bag without degrading an aesthetic appearance of the smart bag by pairing the mobile communication terminal and the smart bag without using a cable.

An exemplary embodiment of the present invention provides a smart bag having a function of notifying a reception of a mobile communication terminal, the smart bag including: a notifying device including a label attached onto one surface of an external side of the smart bag and a backlight combined with one surface of the label; a Bluetooth chip, which is electrically connected with the notifying device and pairs the mobile communication terminal and the notifying device; and a near field communication (NFC) chip, which is attached to one surface of an inner side of the smart bag and activates a Bluetooth function of the mobile communication terminal, in which the Bluetooth chip receives a signal from the mobile communication terminal, so that the backlight is turned on.

When the mobile communication terminal accesses within a predetermined range around the NFC chip, the NFC chip may activate the Bluetooth function of the mobile communication terminal.

The NFC chip may activate the Bluetooth function of the mobile communication terminal, and the Bluetooth chip may pair the notifying device and the mobile communication terminal at the same time.

The backlight may flicker with a different color and a different number of times of flickering according to a type of signal information received from the mobile communication terminal.

The type of signal information may include at least one of a mobile messenger, a text message, a received call, a social network service (SNS), and an email reception notification.

The notifying device may further include a chargeable battery and a button, and when a charging cord is connected to the chargeable battery or the button is pressed for a predetermined time or longer, the backlight may change a light emitting region according to a residual capacity of the battery.

When the pairing between the mobile communication terminal and the notifying device is disconnected, the Bluetooth chip may pair the mobile communication terminal and the notifying device again, and the backlight may flicker with a predetermined pattern until the mobile communication terminal and the notifying device are paired again.

Another exemplary embodiment of the present specification provides a method of notifying a reception of a mobile communication terminal by a smart bag, the method including: when the mobile communication terminal accesses within a predetermined range around a near field communication chip disposed inside the smart bag, activating a Bluetooth function of the mobile communication terminal; pairing a notifying device combined with the smart bag and the mobile communication terminal; transmitting, by the mobile communication terminal, signal information to the notifying device when receiving the signal information from the mobile communication terminal; and receiving, by the notifying device, the signal information and flickering according to the signal information.

In the pairing, the Bluetooth function of the mobile communication terminal may be activated, and a Bluetooth chip electrically connected to the notifying device may pair the notifying device and the mobile communication terminal at the same time.

In the flickering, the notifying device may flicker with a different color and a different number of times of flickering according to a type of signal information received from the mobile communication terminal.

The type of signal information may include at least one of a mobile messenger, a text message, a received call, a social network service (SNS), and an email reception notification.

The method may further include charging the notifying device, in which in the charging of the notifying device, when a charging cord is connected to the notifying device or a button of the notifying device is pressed for a predetermined time or longer, the notifying device may emit light with a light emitting region changed according to a residual capacity of the battery.

The method may further include when the pairing between the mobile communication terminal and the notifying device is disconnected, re-attempting the pairing of pairing the mobile communication terminal and the notifying device again, in which in the re-attempting of the pairing, the notifying device flickers with a predetermined pattern until the mobile communication terminal and the notifying device are paired again.

According to the present invention, even though a mobile communication terminal is located inside the smart bag, it is possible to confirm a received signal from the outside of the smart bag, so that a user may immediately confirm information including a received call and a text message through the mobile communication terminal without missing the information.

According to the present invention, when a mobile communication terminal is in contact with an NFC chip only one time, a pairing state of the mobile communication terminal is maintained even though the mobile communication terminal is located at any place within a predetermined distance from an inner side and an external side of the smart bag, so that a user does not need to pair the mobile communication terminal or connect a cable whenever using the mobile communication terminal, thereby enhancing convenience to a user for use of the mobile communication terminal.

A Bluetooth function of the mobile communication terminal used for pairing is activated by using an NFC chip, so that it is possible to decrease power waste of the mobile communication terminal, which may be incurred when the Bluetooth function is always turned on, and to efficiently use power of the mobile communication terminal only in a required case.

According to the present invention, a mobile communication terminal and the smart bag are paired without using a cable, so that the smart bag may notify a received signal of the mobile communication terminal to the outside of the smart bag even without degrading an aesthetic appearance of the sort of bags generally utilized as a fashion item.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram for describing a smart bag having a function of notifying a reception of a mobile communication terminal according to an exemplary embodiment of the present invention.

FIG. 2 is a diagram for describing a configuration of a notifying device according to an exemplary embodiment of the present invention.

FIG. 3 is a diagram for describing an inner side of the smart bag having the function of notifying the reception of the mobile communication terminal according to the exemplary embodiment of the present invention.

FIG. 4 is a diagram for describing a driving of the notifying device according to the exemplary embodiment of the present invention.

FIGS. 5A to 5D are diagrams for describing an operation of a backlight when a battery is charged according to an exemplary embodiment of the present invention.

FIG. 6 is a flowchart for describing a method of notifying a reception of the mobile communication terminal by the smart bag according to an exemplary embodiment of the present invention.

FIG. 7 is a flowchart for describing a Bluetooth function activation operation according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the exemplary embodiments of the present invention will be described with reference to the accompanying drawings in detail so that those skilled in the art may easily carry out the present invention. First, when reference numerals refer to constituent elements of each drawing, it should be noted that although the same constituent elements are illustrated in different drawings, the same constituent elements are referred to by the same reference numerals as possible. Further, in the following description of the present disclosure, a detailed description of publicly known configurations or functions incorporated herein will be omitted when it is determined that the detailed description may make the subject matter of the present disclosure unclear.

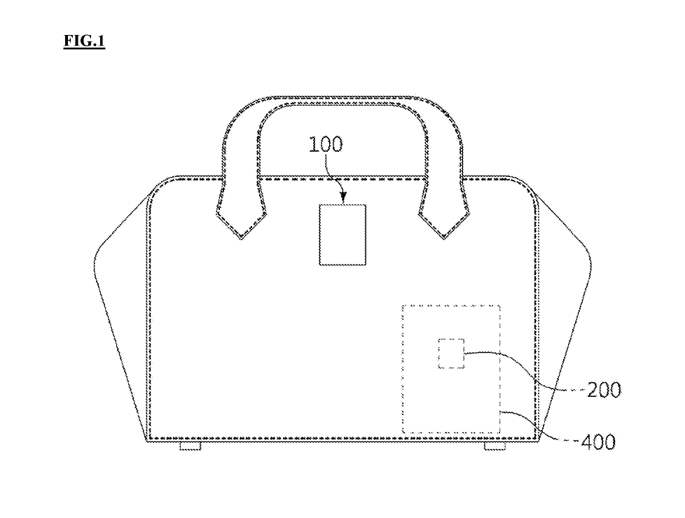

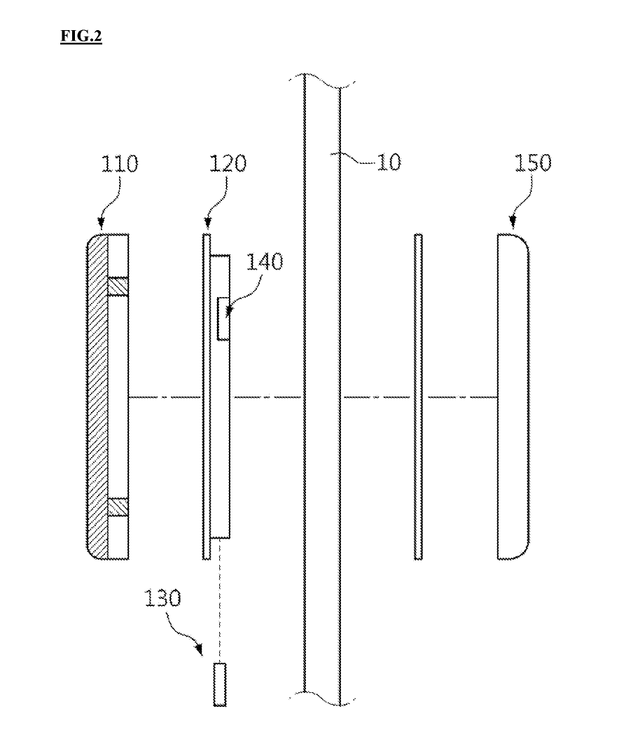

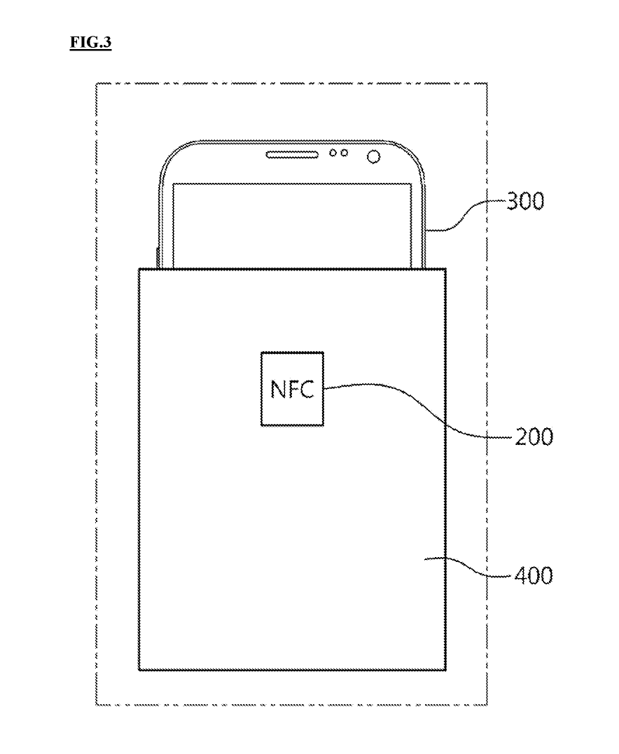

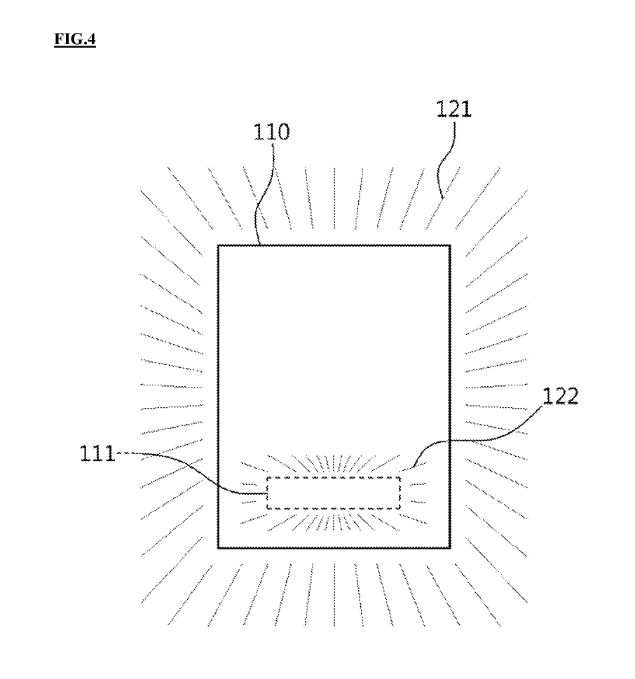

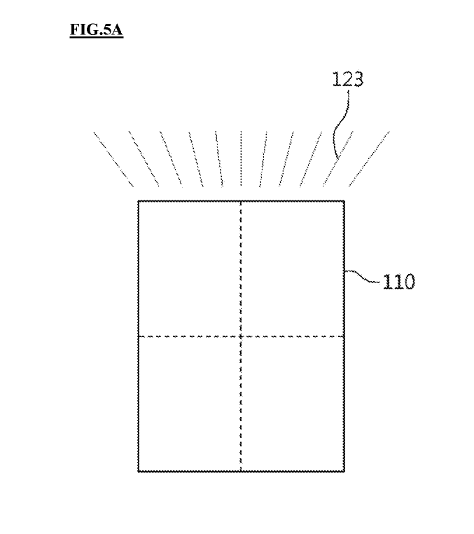

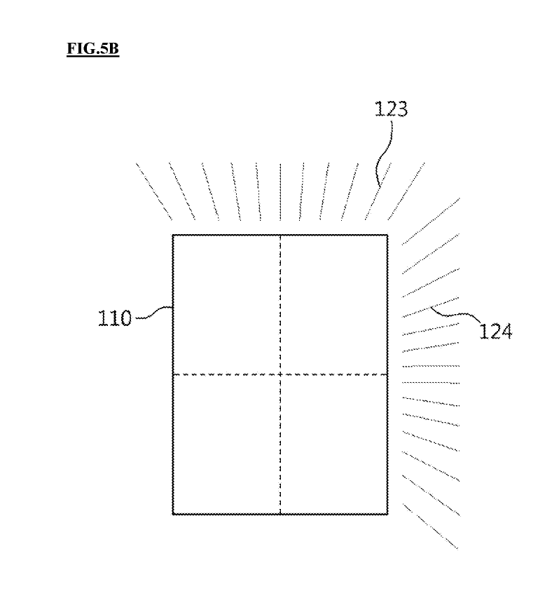

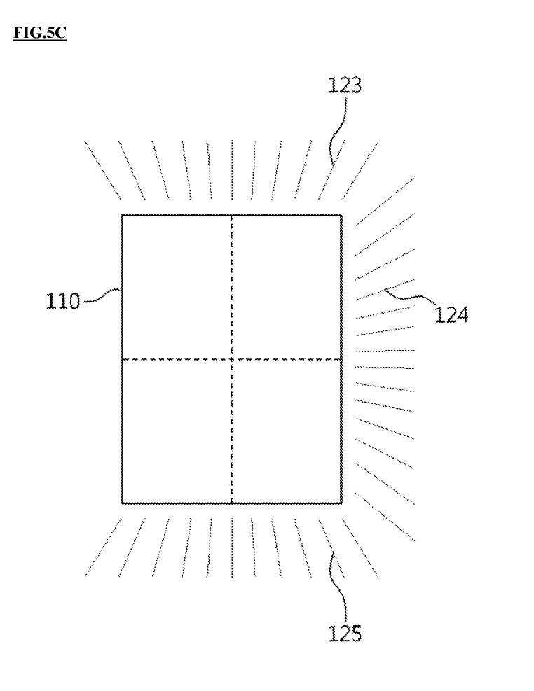

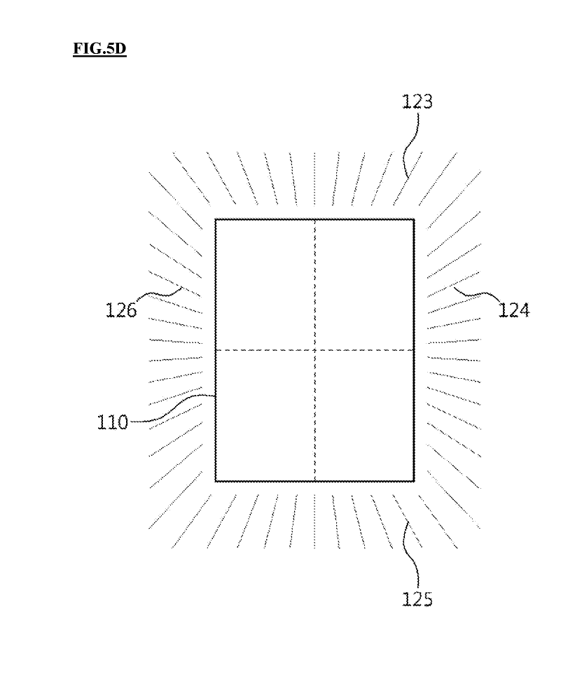

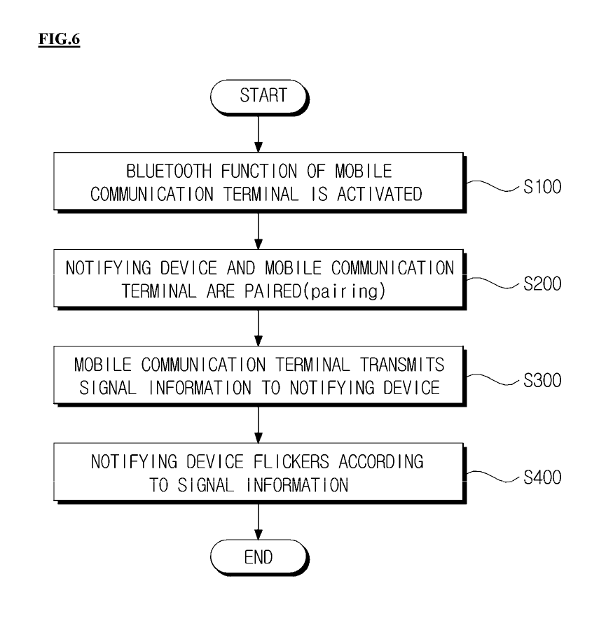

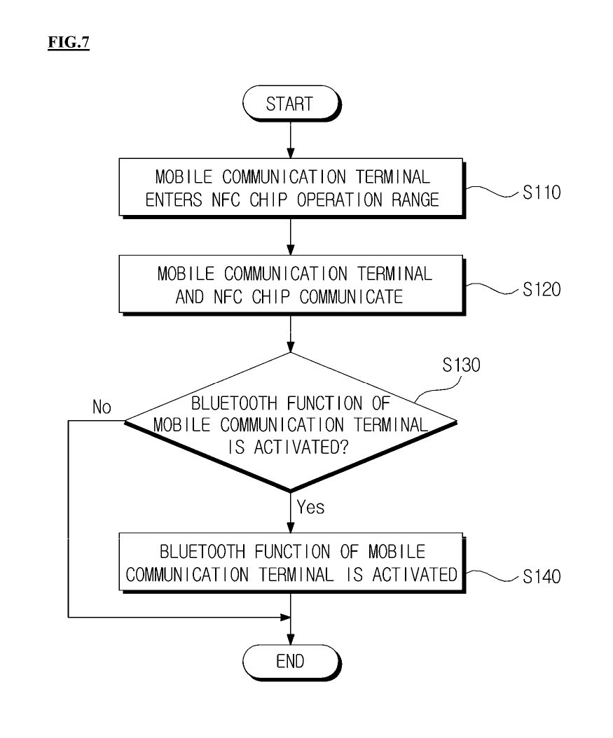

Hereinafter, a smart bag having a function of notifying a reception of a mobile communication terminal according to an exemplary embodiment of the present invention, and a method of notifying a reception by utilizing the same will be described in detail with reference to the accompanying drawings. FIG. 1 is a diagram for describing a smart bag. FIG. 2 is a diagram for describing a configuration of a notifying device. FIG. 3 is a diagram for describing an inner side of the smart bag. FIG. 4 is a diagram for describing a driving of the notifying device. FIGS. 5A to 5D are diagrams for describing an operation of a backlight when a battery is charged. FIG. 6 is a flowchart for describing a method of notifying a reception of the mobile communication terminal by the smart bag. FIG. 7 is a flowchart for describing a Bluetooth function activation operation.

As illustrated in FIG. 1, a smart bag having a function of notifying a reception of a mobile communication terminal includes a notifying device 100, which is attached onto a wall surface of the smart bag and notifies an external side of the smart bag of a reception signal of the mobile communication terminal, a near field communication chip (NFC chip) 200, which is attached onto an inner side of the smart bag and activates a Bluetooth function of the mobile communication terminal, and an accommodating part 400, which makes the mobile communication terminal access a predetermined position inside the smart bag at least one time.

Here, the smart bag refers to the kind of bag, in which the device for notifying the reception of the mobile communication terminal according to the present invention is attached to a hand bag for woman including a tote bag, a shoulder bag, and a shopper bag, and all kinds of fashion accessories including a brief case, a pouch, a trunk, a back pack, and a hip sack conceived for a user to put and conveniently carry a product.

When a Bluetooth function of the mobile communication terminal is activated by using the NFC chip inside the smart bag, the notifying device 100 is paired with the mobile communication terminal. Then, when the mobile communication terminal receives a signal and transmits information about the received signal and the type of received signal to the notifying device 100, the notifying device 100 notifies the external side of the smart bag that the mobile communication terminal receives the signal by using light.

As illustrated in FIG. 2, the notifying device 100 may include a label 110, in which a character is engraved, a backlight 120, which emits light in order to notify the external side of the smart bag of the information about the received signal of the mobile communication terminal in a form of light, a controller 140, which controls an operation of the notifying device 100, and a battery 150, which supplies power to the notifying device 100, and the notifying device 100 may further include a button (not illustrated).

The smart bag may include a Bluetooth chip 130, which is electrically connected with the notifying device 100, and pairs the mobile communication terminal and the notifying device 100, and then receives a signal information type received from the mobile communication terminal.

In this case, a line 10 vertically illustrated in FIG. 2 is a wall surface of the smart bag discriminating the inner side and the external side of the smart bag. That is, the label 110 and the backlight 120 of the notifying device 100 may be positioned outside the smart bag, and the battery 150 of the notifying device 100 may be positioned inside the smart bag, but this is only illustrative, and the respective configurations of the notifying device 100 may be attached to the inner side and the external side of the smart bag within a range, in which those skilled in the art may easily modify the configurations.

The label 110 may be attached onto one surface of the external side of the smart bag, and may be attached in a form completely covering the backlight 120. Further, the label 110 may be formed of a material including a metal material, wood, plastic, and glass, which those skilled in the art are easily usable for covering an external side of an electric device, and a character including a trademark of the smart bag may be engraved in the label 110 by using dimension letters, engraving, and the like. Further, the character may have a slotted form so that light of the backlight 120 may pass through, or may be formed of a transparent material, such as acryl.

The backlight 120 may be combined with one surface of the label 110, and may include a plurality of LEDs. In this case, the backlight 120 is not limited to one including the plurality of LEDs, and may include all kinds of lighting devices for providing light to an electric device. Further, the backlight 120 may emit light with a plurality of different colors under a predetermined condition or may flicker under a predetermined condition, and may divide a section and emit light for each predetermined region.

The Bluetooth chip 130 intermediates the pairing and information exchange between the mobile communication terminal and the notifying device 100. In this case, a Bluetooth function of the mobile communication terminal is activated through the NFC chip 200 and the Bluetooth chip 130 immediately pairs the mobile communication terminal with the notifying device 100 without waiting for a separate command at the same time.

Here, the Bluetooth may be used with low power, and may divide a frequency band and transmit data, so that the Bluetooth may divide and transmit the data over several frequencies. Further, a Bluetooth signal may pass through an obstacle and be transmitted. Further, a usage range of Bluetooth communication is 10 m.

The controller 140 intermediates information exchange between the respective configurations of the notifying device 100, checks a residual capacity of the battery, and checks a pairing state between the mobile communication terminal and the notifying device 100.

The battery 150 may be a battery, which is positioned inside the smart bag, provides power to the notifying device 100, and is detachable. Further, the battery may include all of the batteries including a lithium ion battery and a nickel cadmium battery which those skilled in the art may use for providing power to an electric device. In this case, the battery may be a chargeable battery, and the battery may be charged by a charging cord, and the battery may be charged by using a USB port or a charger of the mobile communication terminal.

As illustrated in FIG. 3, the smart bag may include the NFC chip 200, which is attached onto one surface of the inner side of the smart bag and activates the Bluetooth function of the mobile communication terminal 300, and the accommodating part 400, which makes the mobile communication terminal 300 access an NFC operation region inside the smart bag at least one time therein.

Here, the NFC is a non-contact near field communication method, and is a technology for transmitting data between terminals within a short distance of 10 cm. In this case, when the mobile communication terminal 300 accesses within a predetermined range around the NFC chip 200, the Bluetooth function of the mobile communication terminal 300 is activated, and the mobile communication terminal 300 and the notifying device 100 are paired. In this case, a logo, through which the user may identify a position of the NFC chip 200, may be input into the NFC chip 200.

In this case, when the user does not want the pairing of the mobile communication terminal 300 and the notifying device 100, the mobile communication terminal 300 may receive an input indicating that the mobile communication terminal 300 and the notifying device 100 are not paired through a pre-installed program. In this case, even though the mobile communication terminal 300 accesses within the predetermined range around the NFC chip 200, the Bluetooth function of the mobile communication terminal 300 is not activated.

The accommodating part 400 may be positioned at any place inside the smart bag, and does not essentially need to have a pocket form. That is, the accommodating part 400 may be modified into a form including a cradle form and a pocket form capable of accommodating the mobile communication terminal 300. As described above, the usage range of the Bluetooth is within 10 m, so that it is apparent that when the mobile communication terminal 300 and the notifying device 100 are paired, the mobile communication terminal 300 may maintain a pairing state even though the mobile communication terminal 300 is not essentially positioned in the accommodating part 400.

As illustrated in FIG. 4, the backlight 120 may emit light 121 along a boundary of the label 110, or emit light 122 through a character 111 engraved in the label 110, and individually emit light along each of an upper-end corner, a left-end corner, a right-end corner, and a lower-end corner of the label 110.

When the mobile communication terminal 300 receives the signal and transmits the type of information about the received signal to the Bluetooth chip 130 electrically connected with the notifying device 100 by using the Bluetooth function, the controller 140 transmits the received type of information about the signal to the backlight 120. In this case, the backlight 120 may flicker with different colors and the different number of times according to the type of information about the signal received from the mobile communication terminal. That is, the backlight 120 emits light with predetermined different colors, and emits light with the predetermined different number of times of flickering, and notifies the user of the type of signal currently received in the mobile communication terminal 300 by using the color of light and the number of times of flickering.

Here, the type of information about the signal means the type of information which the user may obtain through the mobile communication terminal including at least one of a mobile messenger, a text message, a received call, a social network service (SNS), and an email reception notification.

In this case, the predetermined different color may be a color selected in consideration of an age and a gender of the user of the smart label, and the mobile communication terminal 300 may receive a color according to a preference of the user through a pre-installed program.

In relation to the predetermined number of times of flickering, the mobile communication terminal 300 may receive the number of times of flickering appropriate to the convenience for the user through a pre-installed program.

Continuously referring to FIG. 4, an operation of the backlight 120 in the smart bag according to the exemplary embodiment of the present invention will be described in more detail.

For example, when the type of information about the signal received by the mobile communication terminal 300 is a text type signal including a mobile messenger and a text message, the predetermined color of light emitted by the backlight 120 may be pink (ruby color), and the predetermined number of times of flickering may be two.

When the type of information about the signal received by the mobile communication terminal 300 is a signal in a type including a received call, which waits for a response of a receiver and requires synchronization with a sender, the predetermined color of light emitted by the backlight 120 may be sky-blue (aqua marine color), and the backlight 120 may continuously flicker while the mobile communication terminal 300 receives a call. In this case, when the call is succeeded, the backlight 120 may be immediately turned off, and when the call is failed and a missing call reception record is left in the mobile communication terminal 300, the backlight 120 may emit light of sky-blue (aqua marine color) for 15 seconds through the region of the character 111 engraved in the label 110.

In the meantime, when the type information about the signal received by the mobile communication terminal 300 is a signal including an SNS in a type based on an online and an email reception notification based on an online, the predetermined color of light emitted by the backlight 120 may be violet (amethyst color), and the predetermined number of times of flickering may be two.

When the mobile communication terminal 300 continuously receives a plurality of signals, the notifying device 100 may transfer information about a signal arriving later to the user by using the predetermined color of light and the predetermined number of times of flickering through the backlight 120.

The backlight 120 of the notifying device 100 provides a pairing state of the notifying device 100 and a residual capacity of the battery, as well as the notification about the type of signal arriving the mobile communication terminal 300, to the user by using the predetermined color of light, the predetermined number of times of light flickering, and a region emitting light.

When the pairing between the mobile communication terminal 300 and the notifying device 100 is disconnected, the Bluetooth chip 130 pairs the mobile communication terminal 300 and the notifying device 100 again. In this case, the backlight 120 is flickered with a predetermined pattern until the mobile communication terminal 300 and the notifying device 100 are paired again. Here, the predetermined pattern means that the backlight 120 emits light with a predetermined color the predetermined number of times of flickering for every predetermined interval.

For example, in relation to the predetermined pattern, when the pairing between the mobile communication terminal 300 and the notifying device 100 is disconnected, the backlight 120 may sequentially flicker and emit light with three different colors for two seconds and repeatedly emit light for a total of three intervals, in which one interval has a standby time of one second, and may subsequently flicker light with the same color for one second two times and emit light until the entire time becomes 100 seconds with an interval, in which one interval has a standby time of five seconds.

As illustrated in FIGS. 5A to 5D, when a charging cord is connected to the battery 150 of the notifying device 100, the backlight 120 may provide information on a residual capacity of the battery to the user while changing a region emitting light according to a current residual capacity of the battery 150, and then may be turned off. Further, the notifying device 100 may further include the button (not illustrated), and when the user presses the button for a predetermined time or longer, the backlight 120 may display a current residual capacity of the battery 150. The predetermined time of pressing the button may be two seconds.

For example, when the residual capacity of the battery 150 is 25%, the backlight 120 is turned on only in one corner region among the upper-end corner, the left-end corner, the right-end corner, and the lower-end corner of the label 110, and emits light 123 through the corresponding corner region (see FIG. 5A). Further, when the residual capacity of the battery 150 is 50%, the backlight 120 is turned on in two corner regions among the upper-end corner, the left-end corner, the right-end corner, and the lower-end corner of the label 110, and emits light 123 and 124 through the corresponding corner regions (see FIG. 5B). Further, when the residual capacity of the battery 150 is 75%, the backlight 120 is turned on in three corner regions among the upper-end corner, the left-end corner, the right-end corner, and the lower-end corner of the label 110, and emits light 123, 124, and 125 through the corresponding corner regions (see FIG. 5C). When the residual capacity of the battery 150 is 100%, the backlight 120 is turned on in all of the regions of the upper-end corner, the left-end corner, the right-end corner, and the lower-end corner of the label 110, and emits light 123, 124, 125, and 126 through all of the corner regions of the label (see FIG. 5D).

The predetermined color of light, the predetermined number of times of flickering, the predetermined interval, and the turned-on region of the backlight 120, which are described with reference to FIGS. 4, and 5A to 5D are simply the exemplary embodiment for helping the understanding of the present invention, and even though the predetermined color of light, the predetermined number of times of flickering, the predetermined interval, and the lighting region of the backlight 120 are changed, the changed predetermined color of light, predetermined number of times of flickering, predetermined interval, and lighting region of the backlight 120 belong to the scope of the present invention.

As illustrated in FIG. 6, in the method of notifying the reception of the mobile communication terminal by the smart bag, when the mobile communication terminal 300 accesses within the predetermined range around the NFC chip 200 disposed inside the smart bag, the Bluetooth function of the mobile communication terminal 300 is activated (S100) and then the notifying device 100 combined with the smart bag and the mobile communication terminal 300 are paired (S200). Then, when the mobile communication terminal 300 receives signal information, the mobile communication terminal 300 transmits the received signal information and the type of received signal information to the notifying device 100 by using the Bluetooth function (S300). Then, when the notifying device 100 receives the signal information and flickers according to the received signal information (S400).

In the pairing operation S200, the Bluetooth function of the mobile communication terminal is activated and the Bluetooth chip electrically connected to the notifying device pairs the notifying device and the mobile communication terminal at the same time.

In this case, the notifying device 100 may use the backlight 120 in order to flicker S400 according to the received signal information, and the notifying device 100 flickers with different colors the predetermined number of times of flickering according to the type of signal information received from the mobile communication terminal 300. That is, the notifying device 100 emits light with predetermined different colors and the predetermined different number of times of flickering, and notifies the user of the type of signal currently received in the mobile communication terminal 300 by using the color of light and the number of times of flickering.

Here, the type of signal information means the type of signal information which the user may obtain through the mobile communication terminal including at least one of a mobile messenger, a text message, a received call, a social network service (SNS), and an email reception notification.

The predetermined different color may be a color selected in consideration of an age and a gender of the user of the smart label, and the mobile communication terminal 300 may receive a color according to a preference of the user through a pre-installed program.

In relation to the predetermined number of times of flickering, the mobile communication terminal 300 may receive the number of times of flickering convenient for the user through a pre-installed program.

The method of notifying the reception of the mobile communication terminal by the smart bag according to the exemplary embodiment of the present invention may further include charging the notifying device when power of the notifying device is insufficient.

In the charging of the notifying device, when the charging cord is connected to the notifying device or the button is pressed for a predetermined time or longer, the notifying device emits light with a light emitting region changed according to the residual capacity of the battery.

The method of notifying the reception of the mobile communication terminal by the smart bag according to the exemplary embodiment of the present invention may further include re-attempting pairing, in which the mobile communication terminal and the notifying device are paired again when the pairing between the mobile communication terminal and the notifying device is disconnected.

In the re-attempting of the pairing, the notifying device flickers with a predetermined pattern until the mobile communication terminal and the notifying device are paired again.

As illustrated in FIG. 7, in the activating of the Bluetooth function of the mobile communication terminal 300 (S100), when the mobile communication terminal 300 moves to a predetermined position inside the smart bag and enters an NFC chip operation range (S110), the mobile communication terminal 300 and the NFC chip communicate with each other (S120).

In this case, the mobile communication terminal 300 may include a pre-installed program, and the mobile communication terminal 300 may receive an input indicating whether to pair the mobile communication terminal 300 and the notifying device 100 through the pre-installed program.

Here, the notifying device 100 determines whether to activate the Bluetooth function of the mobile communication terminal 300 according to whether to pair the mobile communication terminal 300 and the notifying device 100 (S130).

When it is set that the mobile communication terminal 300 and the notifying device 100 are paired, the Bluetooth function of the mobile communication terminal 300 is activated (S140), and when it is set that the mobile communication terminal 300 and the notifying device 100 are not paired, the Bluetooth function of the mobile communication terminal 300 maintains a non-activation state.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A smart bag having a function of notifying a reception of a mobile communication terminal, the smart bag comprising:
a notifying device including a label attached onto one surface of an external side of the smart bag and a backlight combined with one surface of the label;
a Bluetooth chip, which is electrically connected with the notifying device and pairs the mobile communication terminal and the notifying device; and
a near field communication (NFC) chip, which is attached to one surface of an inner side of the smart bag and activates a Bluetooth function of the mobile communication terminal,
wherein the Bluetooth chip receives a signal from the mobile communication terminal, so that the backlight is turned on,
wherein when the mobile communication terminal accesses within a predetermined range around the NFC chip, the NFC chip activates the Bluetooth function of the mobile communication terminal,
wherein the NFC chip activates the Bluetooth function of the mobile communication terminal, and the Bluetooth chip pairs the notifying device and the mobile communication terminal at the same time.

2. The smart bag of claim 1, wherein the backlight flickers with a different color and a different number of times of flickering according to a type of signal information received from the mobile communication terminal.

3. The smart bag of claim 2, wherein the type of signal information includes at least one of a mobile messenger, a text message, a received call, a social network service (SNS), and an email reception notification.

4. The smart bag of claim 1, wherein the notifying device further includes a chargeable battery and a button, and
when a charging cord is connected to the chargeable battery or the button is pressed for a predetermined time or longer, the backlight changes a light emitting region according to a residual capacity of the battery.

5. The smart bag of claim 1, wherein when the pairing between the mobile communication terminal and the notifying device is disconnected, the Bluetooth chip pairs the mobile communication terminal and the notifying device again, and
the backlight flickers with a predetermined pattern until the mobile communication terminal and the notifying device are paired again.

6. A method of notifying a reception of a mobile communication terminal by a smart bag, the method comprising:
when the mobile communication terminal accesses within a predetermined range around a near field communication chip disposed inside the smart bag, activating a he Bluetooth function of the mobile communication terminal;
pairing a notifying device combined with the smart bag and the mobile communication terminal;
transmitting, by the mobile communication terminal, signal information to the notifying device when receiving the signal information from the mobile communication terminal; and
receiving, by the notifying device, the signal information and flickering according to the signal information,
wherein in the pairing, the Bluetooth function of the mobile communication terminal is activated, and a Bluetooth chip electrically connected to the notifying device pairs the notifying device and the mobile communication terminal at the same time.

7. The method of claim 6, wherein in the flickering, the notifying device flickers with a different color and a different number of times of flickering according to a type of signal information received from the mobile communication terminal.

8. The method of claim 7, wherein the type of signal information includes at least one of a mobile messenger, a text message, a received call, a social network service (SNS), and an email reception notification.

9. The method of claim 6, further comprising:
charging the notifying device,
wherein in the charging of the notifying device, when a charging cord is connected to the notifying device or a button of the notifying device is pressed for a predetermined time or longer, the notifying device emits light with a light emitting region changed according to a residual capacity of the battery.

10. The method of claim 6, further comprising:
when the pairing between the mobile communication terminal and the notifying device is disconnected, re-attempting the pairing of pairing the mobile communication terminal and the notifying device again,
wherein in the re-attempting of the pairing, the notifying device flickers with a predetermined pattern until the mobile communication terminal and the notifying device are paired again.
